(19) United States
(12) Patent Application Publication
(10) Pub. No.: US 2007/0180277 A1
(43) Pub. Date: Aug. 2, 2007

(54) Enhanced printer power management

(76) Inventors: Subramanian Jayaram, Austin, TX (US); Santosh Shetty, Round Rock, TX (US)

Correspondence Address: HAMILTON & TERRILE, LLP, P.O. BOX 203518, AUSTIN, TX, 78720, US

(21) Appl. No.: 11/341,977

(22) Filed: Jan. 27, 2006

(51) Int. Cl. G06F 1/26

(52) U.S. Cl. 713/300

(57) ABSTRACT

An improved apparatus and method for reducing printer power consumption, thereby conserving energy and reducing heat generation. A power control circuit automatically transitions a printer from a standby mode to an OFF state when the computer it is attached to is powered down or transitions to an inactive state. In various embodiments of the invention printer power consumption is reduced with corresponding decreases in heat generation, which can extend the life of printer components and increase their reliability, reduce the need for repairs, and prolong effective printer life.

### BACKGROUND OF THE INVENTION

1. Field of the Invention

The present invention relates in general to the field of information system management and more specifically, to printer power consumption management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The number of information handling systems configured for the consumer market has continued to grow over the past several years. Many of these systems are used in conjunction with printers that are often left in a continuous ON state, needlessly consuming power even when the computer systems they are attached to are powered down. Current approaches to reducing printer power consumption consist of transitioning the printer to various standby modes after a predetermined period of inactivity. The length of time before the printer transitions to a standby mode may be contingent upon multiple factors, such as the printer's power consumption when it is in an active mode or its rated print speed (e.g., pages per minute).

When a printer is in a standby mode, it is generally able to conserve energy yet transition to an active state more quickly than if it had been powered down completely. Regardless, while a printer may consume less power in a standby mode, it continues to be in a powered ON state, resulting in wasted energy. Furthermore, since the printer's components are still subjected to electrical power and resulting heat dissipation, their reliability and lifetime can be compromised, potentially shortening the effective lifetime of the printer. In view of the foregoing, there is a need for a system and method for transitioning a printer from a low-power standby mode to an OFF state when the computer it is attached to is powered down.

### SUMMARY OF THE INVENTION

The present invention provides an improved apparatus and method for printer power management. Various embodiments of the invention reduce printer power consumption, thereby conserving energy and reducing heat generation. Decreases in heat generation can extend the life of printer components and increase their reliability, which in turn can reduce the need for repairs and prolong effective printer life.

The present invention allows increased power savings to be realized by automatically transitioning the printer from a low-power standby mode to an OFF state when the computer system it is attached to is powered down. In various embodiments of the invention, a power control circuit is internally implemented on a printer. In an alternate embodiment of the invention, the power control circuit is implemented on a Universal Serial Bus (USB) printer cable without changing the cable's form factor. Those of skill in the art will be aware that USB signals are transmitted on a twisted pair of data cables, labeled D+ and D−. The USB cable also provides a single +5V conductor to power connected USB devices. In an embodiment of the invention, as long as the information handling system controlling the printer is in an ON state, pin 1 of the USB connector will supply +5VDC to the printer. In the case of a dual port USB connector, pins 1 and 6 are +5VDC pins and will operate in a similar manner.

When the internal power control circuit receives a logic high (i.e., +5V) signal from the USB connector, it will conduct the signal and maintain the printer's current power state. When the computer is turned OFF or transitions to an inactive state, pin 1 of the USB connector goes to a logic low (i.e., 1V) signal which causes the power control circuit to transition to an OFF state, which in turn transitions the printer to an OFF power state. In various embodiments of the invention, the manual power switch of the printer overrides the power control circuit of the invention, requiring no change in normal user operation.

Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1a is a generalized illustration of an information handling system that can be used to implement the method and apparatus of the present invention where a power control circuit is implemented on a printer;

FIG. 1b is a generalized illustration of an information handling system that can be used to implement the method and apparatus of the present invention where a power control circuit is implemented on a USB cable without change to the form factor;

FIG. 2a is a generalized block diagram of a USB cable as typically implemented to couple a printer and a host computer;

FIG. 2b is a generalized block diagram of an embodiment of the invention as implemented on a printer to manage power consumption; and

FIG. 2c is a generalized block diagram of an embodiment of the invention as implemented on a USB cable to manage power consumption of a printer; and

FIG. 3 is a generalized schematic diagram of one embodiment of the present invention as implemented on a USB cable.

### DETAILED DESCRIPTION

Information handling system power control circuit automatically transitions printer from a standby mode to an OFF state when the computer it is attached to is powered down or transitions to an inactive state. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Printers that are typically used with information handling systems in a consumer operating environment are often left in a continuous ON state, even when the computer systems they are attached to are powered down. Even if a computer has a usage profile of 12 hours per day, the printer attached to it will often be in either an ON or low-power state for 24 hours per day. The present invention allows increased power savings to be realized by automatically transitioning the printer from a low-power standby mode to an OFF state when the computer system it is attached to is powered down. For example, by implementing the present invention, energy cost savings for a color printer that is capable of printing twenty pages per minute can be calculated as follows. Assuming a rate of $0.08 per Kilowatt hour a usage profile of 12 hours per day, and 70 watts of power consumption in standby mode, the standby mode power cost using current approaches would equate to:
0.070 KW×30 days×12 hours/day×$0.08 per KW hour=$2.016 per month.
This would translate to approximately $24.00 in one year, $73 in 3 years, and $120 in 5 years.

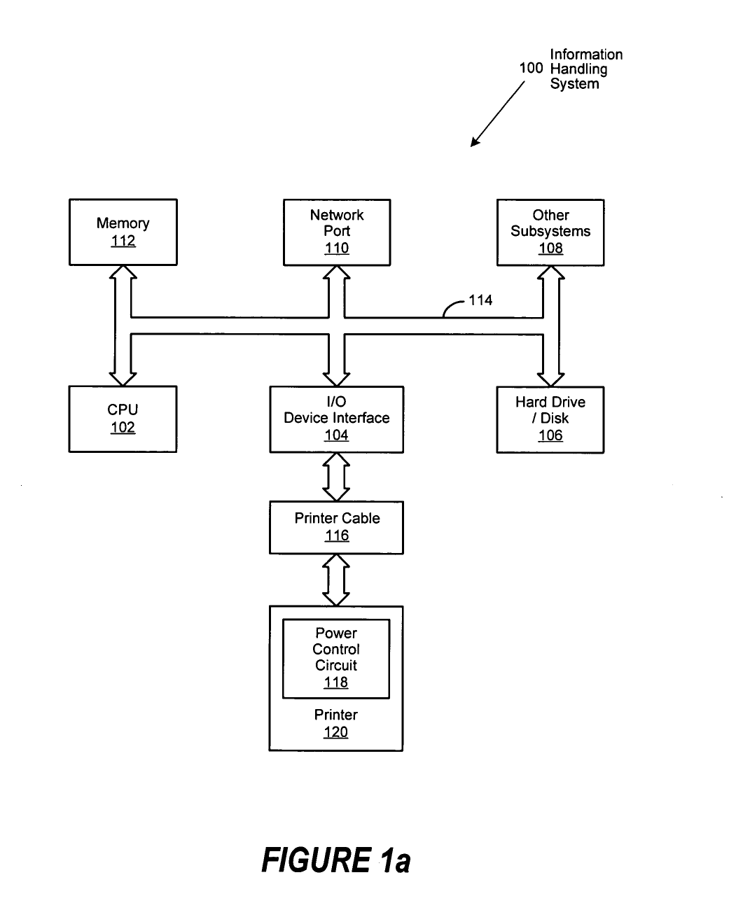

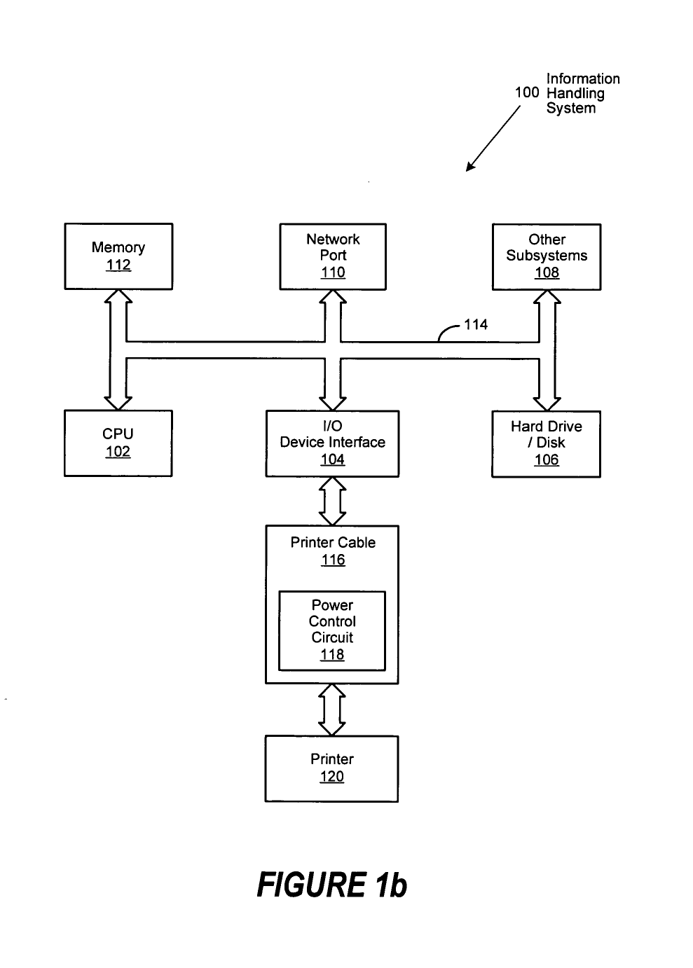

Referring now to FIG. 1a, a block diagram depicts an information handling system 100 that can be used to implement the method and apparatus of the present invention. The functional components of the information handling system include a processor (e.g., central processor unit or “CPU”) 102, input/output (I/O) device interface 104, such as a display, a keyboard, a mouse, a printer, and associated controllers, a hard drive or disk storage 106, various other subsystems 108, network port 110, and system memory 112. Data is transferred between the various system components via various data buses illustrated generally by bus 114. Printer cable 116 couples I/O device interface 104 to printer 120, which comprises power control circuit 118 as described in greater detail below.

Referring now to FIG. 1b, a block diagram depicts an information handling system 100 that can be used to implement the method and apparatus of the present invention. The functional components of the information handling system include a processor (e.g., central processor unit or “CPU”) 102, input/output (I/O) device interface 104, such as a display, a keyboard, a mouse, a printer, and associated controllers, a hard drive or disk storage 106, various other subsystems 108, network port 110, and system memory 112. Data is transferred between the various system components via various data buses illustrated generally by bus 114. Printer cable 116 comprises power control circuit 118, which couples I/O device interface 104 to printer 120 as described in greater detail below.

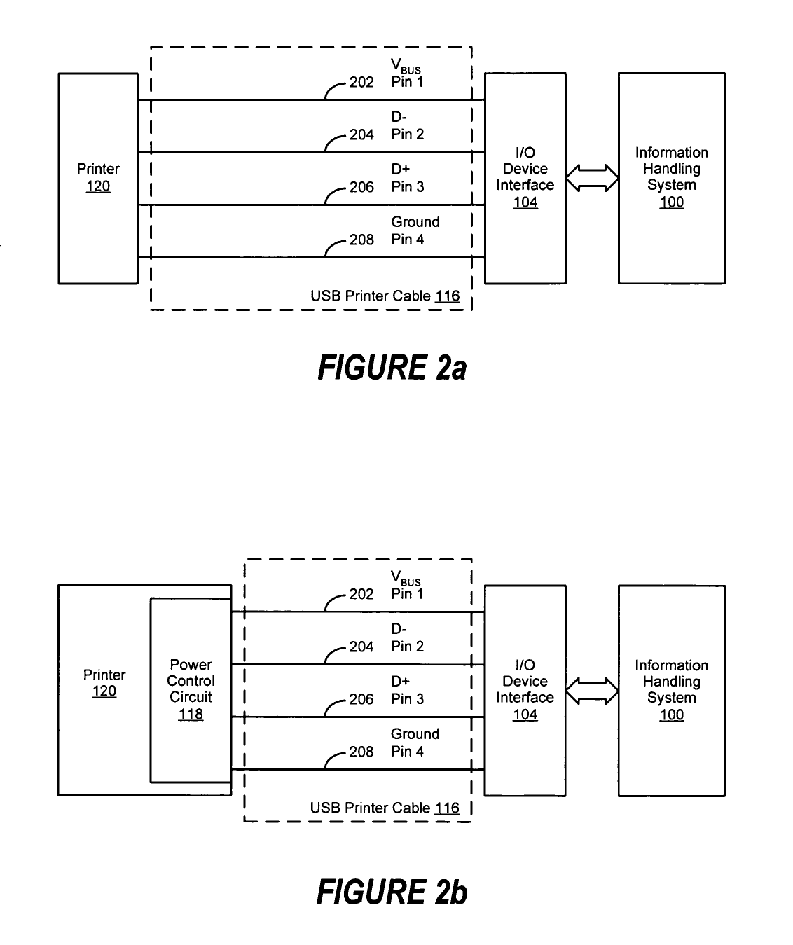

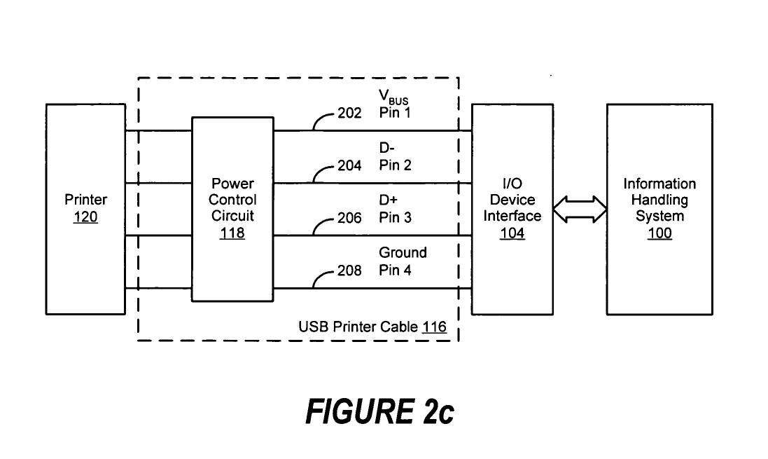

FIG. 2a is a generalized block diagram of a USB cable 116 as typically implemented to couple a printer 120 to host computer device interface 104, which in turn is coupled to information handling system 100. As will be understood by skilled practitioners of the art, USB printer cable 116 is typically comprised of conductor 202, which carries a nominal V_{BUS} voltage of 5V via pin 1 of a USB cable, conductor 204, which carries D+ data signals via pin 2 of a USB cable, conductor 206, which carries D− data signals via pin 3 of a USB cable, and conductor 208, which provides a ground on pin 4 of a USB cable.

FIG. 2b is generalized block diagram of an embodiment of the invention wherein power control circuit 118 is implemented on printer 120 to manage power consumption. In various embodiments of the invention, power control circuit 118 is implemented on conductor 202 of USB printer cable 116, which carries a nominal V_{BUS} voltage of 5V. Those of skill in the art will be aware that the V_{BUS} conductor, generally implemented on pin 1 of a USB cable, is capable of supplying power to unpowered USB peripherals. The V_{BUS} conductor can also be used by a host computer to manage power events such as suspend or resume, typically through the implementation of USB software on the host.

However, internal power control circuit 118 of the present invention does not require implementation of software. Instead, it monitors the presence of a logic high (e.g., +5V) signal on conductor 202 of USB cable 116. If present, it will conduct the signal and maintain the printer's current power state. When host information handling system 100 is turned OFF or transitions to an inactive state, conductor 202 of USB cable 116 goes to a logic low (e.g., 0V) signal, which causes power control circuit 118 to transition to an OFF state, which in turn transitions printer 120 to an OFF power state. In various embodiments of the invention, the manual power switch of printer 120 overrides power control circuit 118 of the invention, requiring no change in normal user operation.

FIG. 2c is generalized block diagram of an alternate embodiment of the invention wherein power control circuit 118 is implemented on USB cable 116 to manage power consumption of printer 120. In various embodiments of the invention, power control circuit 118 is implemented on conductor 202 of USB printer cable 116, and monitors the presence of a logic high (e.g., +5V) signal. If present, it will conduct the signal and maintain the printer's current power state. When host information handling system 100 is turned OFF or transitions to an inactive state, conductor 202 of USB cable 116 goes to a logic low (e.g., 0V) signal, which causes power control circuit 118 to transition to an OFF state, which in turn transitions printer 120 to an OFF power state. In various embodiments of the invention the manual power switch of printer 120 overrides power control circuit 118 of the invention, requiring no change in normal user operation.

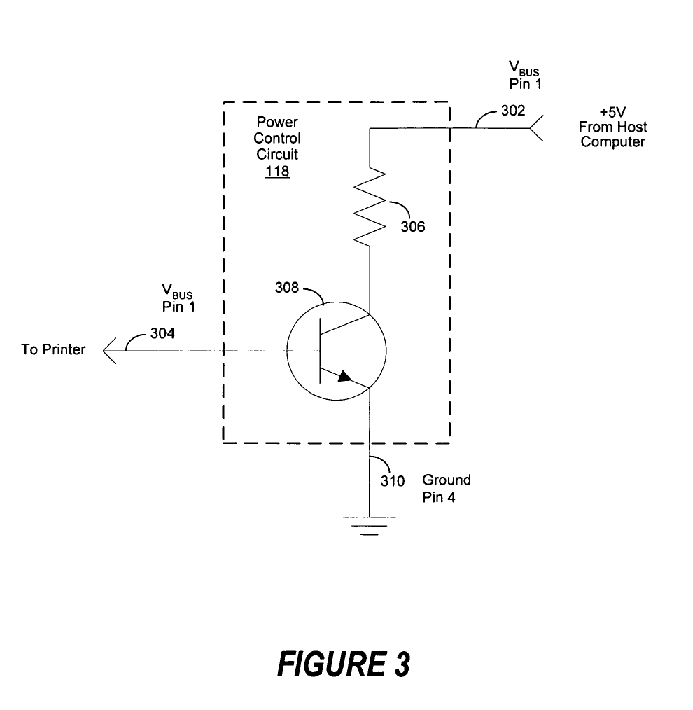

FIG. 3 is a generalized schematic diagram of one embodiment of the present invention. In one embodiment of the invention, power control circuit 118 comprises resistive load 306 and transistor 308 and is implemented between incoming USB V_{BUS} conductor 304, which carries a nominal voltage of 5V from I/O device interface 104 coupled to information handling system 100, outgoing USB V_{BUS} conductor 304 coupled to printer 120, and ground conductor 310 of USB cable 116.

In this embodiment, power control circuit 118 monitors the presence of a logic high (i.e., +5V) signal on incoming USB V_{BUS} conductor 304. As long as information handling system 100 controlling printer 120 is in an ON state, incoming USB V_{BUS} conductor 304 will supply +5VDC to transistor 308 of power control circuit 118, which will conduct the incoming V_{BUS} voltage and the printer will maintain its current power state. When information handling system 100 is turned OFF or transitions to an inactive state, incoming USB V_{BUS} conductor 304 of USB cable 116 goes to logic low state (i.e., 0V), which causes transistor 116 of power control circuit 118 to transition to an OFF state, which in turn transitions printer 120 to an OFF power state. The manual power switch of printer 120 is operable to override power control circuit 118 of the invention, requiring no change in normal user operation.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for managing power consumption of a printer, comprising:
a cable operable to couple said printer to an information handling system;
power control circuitry coupled to said cable, said power control circuitry being operable to change the power consumption of said printer in response to a change in the operating state of said information handling system.

2. The system of claim 1, wherein said power control circuitry is integrated into said printer.

3. The system of claim 1, wherein said power control circuitry is integrated into said cable.

4. The system of claim 1, wherein said power consumption of said printer is decreased in response to said change in the operating state of said information handling system.

5. The system of claim 1, wherein said printer is placed in a standby mode in response to said change in the operating state of said information handling system.

6. The system of claim 1, wherein said power consumption of said printer is reduced to zero power consumption in response to said change in the operating state of said information handling system.

7. The system of claim 2, wherein said cable comprises a universal serial bus (USB) cable.

8. The system of claim 6, wherein said power control circuitry is operably connected to a conductor in said USB cable.

9. The system of claim 7, wherein said power control circuitry changes the power consumption of said printer in response to a change in the voltage applied to said conductor.

10. The system of claim 1, wherein said system further comprises a manual switch operable to change the power consumption of said printer.

11. A method of managing power consumption of a printer, comprising:
using a cable to operably couple said printer to an information handling system; and
using power control circuitry to change the power consumption of said printer in response to a change in the operating state of said information handling system, wherein data corresponding to the operating state of said information handling system is communicated to said power control circuitry by said cable.

12. The method of claim 11, wherein said power control circuitry is integrated into said printer.

13. The method of claim 11, wherein said power control circuitry is integrated into said cable.

14. The method of claim 11, wherein said power consumption of said printer is decreased in response to said change in the operating state of said information handling system.

15. The method of claim 11, wherein said printer is placed in a standby mode in response to said change in the operating state of said information handling system.

16. The method of claim 11, wherein said power consumption of said printer is reduced to zero power consumption in response to said change in the operating state of said information handling system.

17. The method of claim 12, wherein said cable comprises a universal serial bus (USB) cable.

18. The method of claim 16, wherein said power control circuitry is operably connected to a conductor in said USB cable.

19. The method of claim 17, wherein said power control circuitry changes the power consumption of said printer in response to a change in the voltage applied to said conductor.

20. The method of claim 11, wherein said printer further comprises a manual switch operable to change the power consumption of said printer.
